(19) United States
(12) Patent Application Publication
(10) Pub. No.: US 2018/0134618 A1
(43) Pub. Date: May 17, 2018

(54) Drain Pipe and Manufacturing Method Therefor

(71) Applicant: MYUNG SECK LIM, Euijungbu-si Kyungki-do (KR)

(72) Inventor: MYUNG SECK LIM, Euijungbu-si Kyungki-do (KR)

(21) Appl. No.: 15/810,750

(22) Filed: Nov. 13, 2017

(30) Foreign Application Priority Data
Nov. 14, 2016 (KR) 10-2016-0150941

(51) Int. Cl. C04B 16/06; C04B 14/06; C04B 14/00; C04B 24/42; C04B 24/02; C04B 24/26; B28B 21/30

(52) U.S. Cl. CPC C04B 16/0641; C04B 14/06; C04B 14/005; B28B 21/30; C04B 24/02; C04B 24/2641; C04B 24/42

(57) ABSTRACT

A drain pipe is manufactured from a cement mixture which comprises cement 20-30 weight percent, sand 30-40 weight percent, broken-stone chip 31-45 weight percent in 4-20 mm size, admixture 0.2-0.3 weight percent, and functional additives. The functional additives shall be added and mixed additionally. The functional additives include PUD (Waterborne Polyurethane Dispersion) 10-15 weight percent, PVA (Polyvinyl Alcohol) fiber 4-8 weight percent in 2-3 mm size, MEHEC (methylethylhydroxyethylcelluloe) 2-4 weight percent, calcium carbonate 4-6 weight percent, degenerated silicate 2-4 weight percent, epoxy group emulsion 1-2 weight percent, fluorosilicate magnesium 1-2 weight percent, cyclopentasiloxane 1-2 weight percent, triglycerides 6-10 weight percent, glycidyl neodecanoate 2-4 weight percent, sodium, acrylate copolymer 2-4 weight percent and dichlorodimethylsilane 3-6 weight percent, and water for remaining portion based on cement 100 weight percent.

### CROSS-REFERENCE TO RELATED APPLICATION

This application claims priority based on Korean Patent Application No. 10-2016-0150941 filed on Nov. 14, 2016, the disclosure of which is incorporated by reference as if it is set forth herein.

### FIELD OF THE INVENTION

The present invention is related to a drain pipe manufactured by using centrifugal force. In more detail, it is related to the manufacture of a drain pipe that has a seating groove where a trench cover is seated & installed at top, by using centrifugal force, which suppresses neutralization and extends life span, also fundamentally prevents poor construction to be caused by water leakage, by preventing cracks that occur when used for a long time.

### DESCRIPTION OF THE PRIOR ART

Generally, a drain pipe is installed so that wastewater or rainwater is drained smoothly from the ground in parking lot in apartment, public parking lot and recreational facility like park, or on general roadside.

Traditional drain pipe has a blocked structure in which a cover is covered at top of body having a “U” shaped waterway. However, a drain pipe having such structure has problem that the body and the cover can be separated and damaged easily due to subsidence of ground or earth pressure.

Therefore, recently an integrated drain pipe is manufactured without distinction between body and cover, using centrifugal force.

That is, a forming method by using centrifugal force puts cement inside forming mold and spins it in order to form a drain pipe by centrifugal force, by which a drain pipe can be manufactured in integrated type without distinction between top and bottom.

In Korean registered utility model No. 20-0331596, an example of forming mold of drain pipe is disclosed. But, the forming mold of drain pipe disclosed in this utility model has very complicated structure, therefore, productivity is low and furthermore it has weakness that with this forming mold, it cannot form the latest drain pipe which has seating groove where trench cover is seated and installed at top. Other prior art includes Korea patent registration No. 10-0455616 (Oct. 26, 2004) “Culvert drain pipe manufacturing equipment,” Korea patent registration No. 10-1116201 (Feb. 7, 2012) “Forming mold of drain pipe by using centrifugal force and method of manufacturing drain pipe by using this mold.”

The Applicant applied “Forming mold of drain pipe by using centrifugal force and method of manufacturing drain pipe by using this mold” for patent as of Dec. 13, 2011, and it was patented as registration No. 10-1116201 (Feb. 7, 2012).

While the Applicant has been constructing drain pipe, using above-mentioned registered patent, the necessity for extension of lifespan of drain pipe has been brought up, so based on years of experience, we have continued our research over and over, and eventually we have completed this invention.

### SUMMARY OF THE INVENTION

In consideration of previous problems in technical aspect as mentioned above in detail, this invention is created to solve such problems, and its main purpose is to manufacture and provide drain pipe that has a seating groove where a trench cover is seated & installed at top, by using centrifugal force, which suppresses neutralization, extends life span, also fundamentally prevents poor construction to be caused by water leakage, by preventing cracks that occur when used for a long time.

In order to achieve the above objectives, the present invention provides a drain pipe, wherein the drain pipe is manufactured from a cement mixture which is composed of cement 20-30 weight percent, sand 30-40 weight percent, broken-stone chip 31-45 weight percent in 4-20 mm size, admixture 0.2-0.3 weight percent, functional additives, wherein the functional additives shall be added and mixed additionally, wherein the functional additives are composed of PUD (Waterborne Polyurethane Dispersion) 10-15 weight percent, PVA (Polyvinyl Alcohol) fiber 4-8 weight percent in 2-3 mm size, MEHEC (methylethylhydroxyethylcelluloe) 2-4 weight percent, calcium carbonate 4-6 weight percent, degenerated silicate 2-4 weight percent, epoxy group emulsion 1-2 weight percent, fluorosilicate magnesium 1-2 weight percent, cyclopentasiloxane 1-2 weight percent, triglycerides 6-10 weight percent, glycidyl neodecanoate 2-4 weight percent, sodium acrylate copolymer 2-4 weight percent and dichlorodimethylsilane 3-6 weight percent, and water for remaining portion based on cement 100 weight percent.

Preferably, butyl acetate 3-6 weight percent, based on cement 100 weight percent, is added to the cement mixture.

Preferably, polyamine 2-4 weight percent and isopropyl alcohol 2-4 weight percent, based on cement 100 weight percent, are added to the cement mixture.

The drain pipe is manufactured by a method comprising steps of a) preparing a forming mold; b) injecting the cement mixture into the forming mold; c) spinning the forming mold to form the drain pipe by centrifugal force; d) moving the drain pipe to a steam curing room without detaching the mold; e) steam curing the drain pipe for a predetermined period of time at predetermined temperature; and f) once steam curing is completed, detaching the forming mold to separate the drain pipe. The drain pipe further comprises a guide channel provided at one end of the drain pipe and an insert provided at the other side of the drain pipe, and is guided into the guide channel when two adjacent drain pipes are assembled, wherein the guide channel and the insert are provided on the inclined surface of the drain pipe so that the guide channel and the insert do not protrude beyond the width the drain pipe.

The present invention has advantageous effects of depressing neutralization, extending lifespan and fundamentally preventing poor construction to be caused by water leakage, by preventing cracks that occur when used for a long time.

### BRIEF DESCRIPTION OF THE DRAWINGS

In the drawings:

FIG. 1 is a perspective view that shows a drain pipe formed by this invention;

FIG. 2 is an exploded perspective view that shows construction of a mold to manufacture the drain pipe, using centrifugal force according to this invention;

FIG. 3 is a cross-sectional view of the mold that shows assembled state of coupled molds to manufacture drain pipe, using centrifugal force according to this invention;

FIG. 4 is a cross-sectional view that shows coupled state of a spacer in this invention;

FIGS. 5a-5d are schematic diagrams that show a process to manufacture the drain pipe;

FIGS. 6a and 6b are front elevation views showing a guide to facilitate assembly of drain pipes; and

FIGS. 7 and 8 are side elevation views showing the guide.

### DESCRIPTION OF PREFERRED EMBODIMENTS

Preferred embodiment of the present invention are explained below in detail by referring to the attached drawings.

Prior to explanation of this invention, following specific structure or functional explanation is illustrative only for the purpose of explaining example of implementation according to concept of this invention, and example of implementation in accordance with concept of this invention can be carried out in various types and it shall not be construed that implementation of this invention is limited only to the example of implementation explained in this statement.

Also, the example of implementation according to concept of this invention can be changed in various ways and can have various types, therefore we are going to illustrate specific example of implementation in drawing and explain them in detail in this specification. However, it is not intended to limit example of implementation according to concept of this invention to the specific clearly-expressed type, and it should be understood so that all modification, equivalent or substitution should be included which contains idea and technological scope of this invention.

Also, this specification includes construction of registered patent (No. 10-1116201, Feb. 7, 2012) by this applicant. However, the present invention has characteristic in which functional additives are added to the cement mixture to achieve purpose of this invention, and these functional additives are explained in detail below.

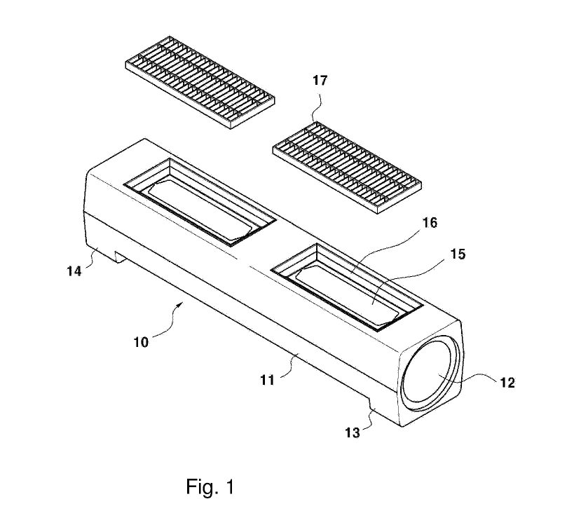

Referring to FIG. 1, an upper surface of a body (11) of a drain pipe (10) manufactured by this invention using centrifugal force is formed horizontally, and on this upper surface, two seating grooves (15) where a trench cover (17) is seated are formed, being spaced at a certain interval.

And an upper sidewall of the body (11) is formed, being inclined for width to become wider as going downwards from the top, so that it can be easily detached from an upper mold (100) to be explained later.

Also, a front supporting block (13) and a rear supporting block (14), the bottom of which are flat, are formed integrally so that front and rear parts of body (11) are placed stably on the floor. And sidewalls of the front-supporting block (13) and the rear-supporting block (14) are formed, being inclined for width to become narrower as going downwards from middle so that they can be easily detached from a bottom mold (200) to be explained later.

A long round waterway (12) is formed longitudinally inside the body (11) and the waterway is formed so that it is linked with the seating groove (15) for water to flow through.

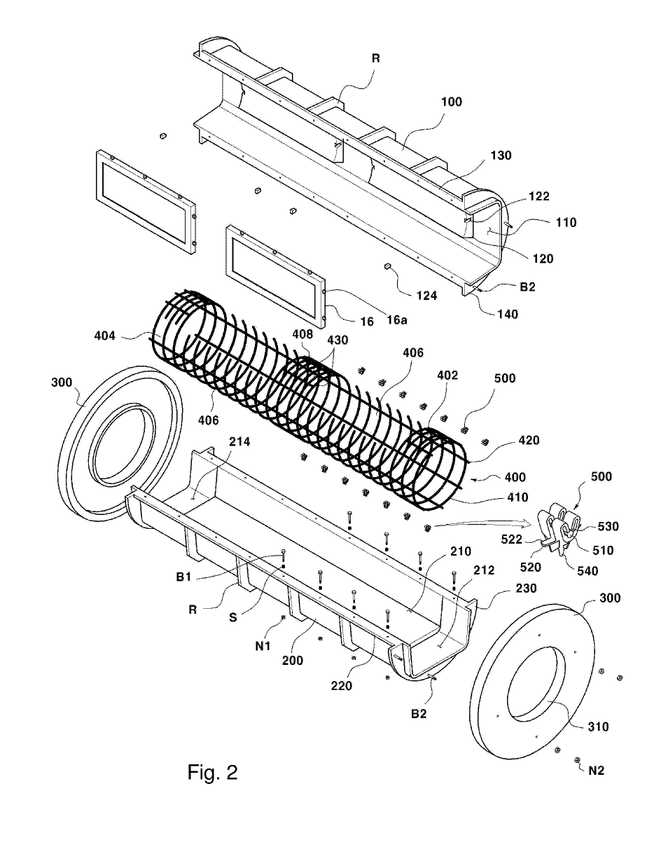

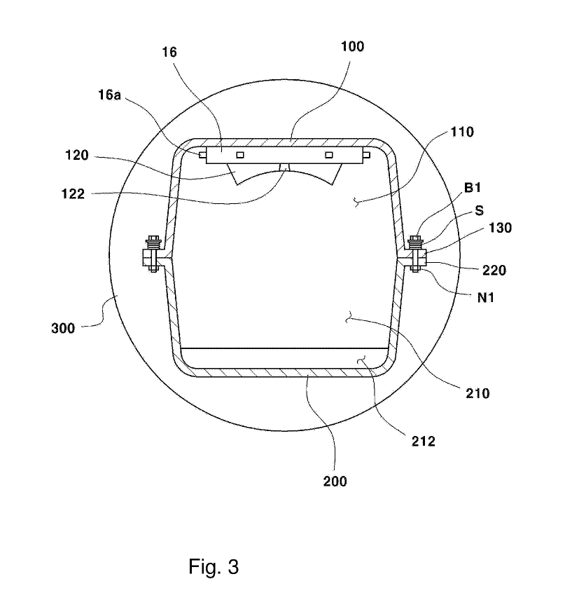

As illustrated in FIGS. 2-4, a forming mold to manufacture the drain pipe according to this invention comprises the upper mold (100), the bottom mold (200), round disks (300) and an iron core (400).

Inside the upper mold (100), an upper body forming space (110) that forms the upper part of the drain pipe body (11), is formed. The upper body forming space (110) is open downwards and top side is formed horizontally, while both sides are formed, being inclined so that width become wider as going downwards from the top.

The reason that both sides are formed to be inclined here is for the upper mold (100) to be detached easily after the drain pipe (10) is completely formed.

And on top of the upper body forming space (110), seating groove forming blocks (120) are placed, projecting downwards so that seating groove (15) where the trench cover (17) is installed, is formed.

The seating groove forming blocks (120) are placed in two areas at certain interval, and each shape of front, side and rear part has incline that becomes narrower as going downwards from the top so that the trench cover can be detached easily from the seating groove of the drain pipe (10) when the drain pipe (10) is formed. It is desirable to make bottom surface of block to be round in arc shape so that spin shall not be interrupted when drain pipe is formed by centrifugal force.

A upper flange unit (130) is formed in the upper mold (100) to connect with the bottom mold (200) along with edge, and at front and rear area, a round disk coupling upper flange unit (140) is formed so that the round disk (300) can be coupled.

Many ribs (R) are formed along the outer periphery of the upper mold (100) to reinforce strength.

In addition, an edge member (16) forming the edge of seating groove (15) when the drain pipe (10) is formed, is inserted and assembled in the seating groove forming block (120).

Also, the edge member (16) has rectangular frame shape of which inside is empty, and is manufactured by metal material.

Also, when assembled in the seating groove forming block (120), it is fixed by a key (124) to be inserted into a key groove (122) which is formed in the seating groove forming block (120).

In other words, when the key (124) is inserted into the key groove (122) while the edge member (16) being inserted into the seating groove forming block (120), the key holds the edge member (16) firmly, which maintains fixing condition so that the edge member (16) is not separated.

And, on the front, side and rear area of the edge member (16), a coupling bump (16a) is formed in projected shape, so that the edge member (16) is fixed firmly, being embedded inside drain pipe, without separation when drain pipe is formed.

In addition, the bottom mold (200) is assembled to the upper mold (100) to be combined into one, and a bottom body forming space (210) which forms bottom of drain pipe body (11) is formed inside so as to communicate with upper body forming space (110).

At this time, the bottom body forming space (210) is opened upwards and it has semi-circular shape generally. On front and rear bottom, a front-supporting block forming space (212) and a rear-supporting block forming space (214) is formed respectively which is formed deeper than semi-circular bottom.

Also, the bottom of front-supporting block forming space (212) and rear-supporting block forming space (214) is formed horizontally so that it has horizontal bottom for drain pipe (10) to be installed stably on the ground.

And, along with the edge of the bottom mold (200), a bottom flange unit (220) corresponding to upper flange unit (130) is formed so that they are coupled firmly each other with bolts (B1) and nuts (N1).

At this time, when the upper flange unit (130) and the bottom flange unit (220) are coupled together with bolts (B1) and nuts (N1) to combine the upper mold and the bottom mold, it is desirable to insert a spring (S) between bolts (B1) and upper flange unit (130) so that they can be fixed more firmly by means of restoring force of the spring.

Further, at front and rear of the bottom mold (200), it has structure that a round disk coupling bottom flange unit (230) is formed, corresponding to the round disk coupling upper flange unit (140).

Also, many ribs (R) are formed along with outer edge of the bottom mold (200) to reinforce strength.

In addition, the round disk (300) plays a role of roller when the upper mold and the bottom mold is rotated by centrifugal force to form a drain pipe. It is assembled at front and rear while the upper mold and the bottom mold are coupled together, and coupled firmly with the round disk coupling upper flange unit (140) and the round disk coupling bottom flange unit (230) with bolts and nuts.

In other words, on the round disk coupling upper flange unit (140) and the round disk coupling bottom flange unit (230), bolts (B2) which are installed fixedly, are formed in projected shape and on the round disk (300), fixing holes are formed, therefore you can push the round disk into bolts (B2) through the fixing holes and fix it with nuts (N2).

And, a penetration hole for exposing the upper body forming space (110) and the bottom body forming space (210) is formed in the center of the round disk.

Therefore, through the penetration hole (310), cement can be injected to the upper body forming space (110) and the bottom body forming space (210).

Also, an iron core (400) is inserted inside when the upper body forming space (110) is combined with the bottom body forming space (210), and it forms frame, being embedded inside the drain pipe, when the drain pipe is formed. The iron core is composed of many circular iron cores (410) formed at certain interval and many connecting iron cores (420) which are straight and connect circular iron cores together, being welded with them.

Meanwhile, if iron cores are classified by section, they can be classified into 4 sections, that is, a front block supporting section (402) embedded in the front supporting block (13) of the drain pipe, a rear block supporting section (404) embedded in the rear supporting block (14) of the drain pipe, a seating groove supporting section (406) embedded around the seating groove (15) of drain pipe, and an intermediate connection supporting section (408) embedded in connecting area between the seating grooves (15) of the drain pipe.

And, the connection area between the seating grooves (15) is a section that many people step on frequently, therefore, to reinforce strength of the drain pipe, it is desirable to have compact structure in the intermediate connection supporting section (408) of the iron core (400) by welding many reinforcing iron cores (430) more at the top.

Of course, in order to reinforce strength, additional reinforcing iron cores (430) may be welded more on top of the front block supporting section (402) and the rear block supporting section (404).

When such iron cores (400) are inserted between the upper body forming space (110) and the bottom body forming space (210), many spacers (500) are inserted into the iron cores (400) and coupled so as to maintain a certain distance, apart the from upper body forming space (110) and the bottom body forming space (210).

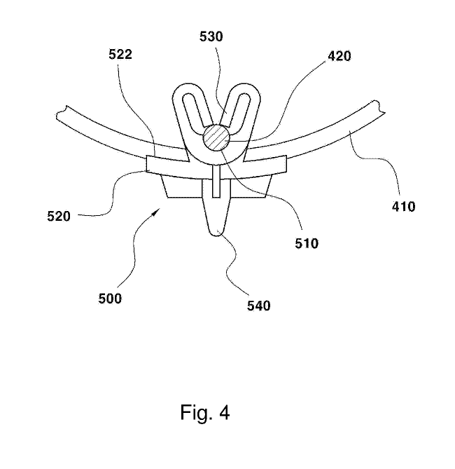

Referring to FIG. 4, on top of the spacer (500), a connecting iron core insertion groove (510) is formed, and on top of the connecting iron core insertion groove (510), there is a connecting iron core separation preventive piece (530), which guides insertion of connecting iron core (420) as well as holds the connecting iron core (420) inserted in the connecting iron core insertion groove (510) not to be taken out, is formed so as to have elasticity. On the middle area, a circular iron core seating piece (520) is formed at right angle to the connecting iron core insertion groove (510). On the top of the circular iron core seating piece, a circular iron core seating groove (522) is formed being round in arc shape. Also on the bottom, an interval maintaining bump (540) is projecting out which would be in contact with the upper body forming space (110) or the bottom body forming space (210), being extended to downward direction.

Such spacer is classified into two, that is, a basic type that the iron core (400) is inserted in intermediate area and a deformed type that the iron core is inserted in the front block supporting section (402) and the rear block supporting section (404).

And, the basic type and the deformed type have the same structure respectively, however in the deformed type, the interval maintaining bump (540) is extended longer, compared with the basic type, so that the bump can be in contact with inside of the front-supporting block forming space (212) and the rear-supporting block forming space (214).

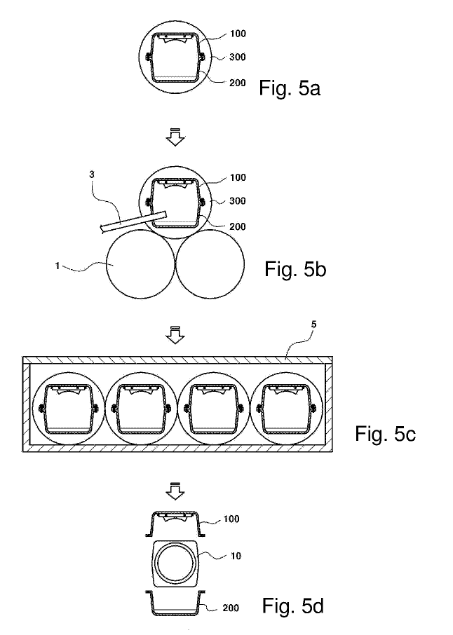

Referring to FIGS. 5a-5d, a method to manufacture a drain pipe by using centrifugal force, with the drain pipe forming mold composed as specified above, is explained as below.

First, assemble the forming mold.

That is, place the iron core (400) on the bottom body forming space (210) of the bottom mold (200), and assemble the mold so that the upper mold (100) is combined to the bottom mold (200) while leaving the iron core in between.

At this time, insert the spacer (500) into the iron core (400) so that the iron core can maintain certain distance away from the bottom body forming space (210) and the upper body forming space (110).

Under this condition, couple the upper mold (100) and the bottom mold (200) firmly with bolts and nuts which fix the flange, passing through the upper flange unit (130) and the bottom flange unit (220).

Thereafter, assemble the round disk (300) to front and rear of the upper mold and the bottom mold respectively.

At this time, place the round disk in close contact with the round disk coupling upper flange unit (140) and the round disk coupling bottom flange unit (230) which is formed at front and rear of the upper mold and the bottom mold, and fix it by tightening nuts onto bolts.

Next, inject cement mixture into inside of the assembled mold, i.e. the bottom body forming space (210) and the upper body forming space (110), and place the assembled mold on top of a rotor (1) which rotates mold to one direction, and rotate it.

Then, as the round disk (300) rotates with the roller and rotor as well, the mold also rotates, and the mold forms a drain pipe (10) while the mixture adhere to inside of the mold by means of centrifugal force.

The cement mixture to be used for this process is composed of cement 20-30 weight percent, sand 30-40 weight percent, broken-stone chip 31-45 weight percent in 4-20 mm size, admixture 0.2-0.3 weight percent and water for remaining portion. General Portland cement or white cement may be used individually, or as mixture.

And, sand should be of same color and sand having particle diameter less than 5 mm is recommended.

Broken-stone chip should be inorganic natural mineral which has good color and strength above a certain level, and it should maintain its own strength to the extent that it shall not affect realization of standard strength, while its size shall be 4-20 mm.

Also, the admixture means chemical admixture to be used for concrete, in this example of implementation, naphthalene-group intrinsic anabolic agent may be used, and addition of 0.2-0.3 weight percent is recommended.

Also, pigment may be added and you can make color as you want by mixing basic colors (Red, blue, yellow, black and white) appropriately. And general organic pigment or inorganic pigment may be used, and addition of 1.5-2.5 weight percent based on above mentioned cement 100 weight percent, is desirable.

Next, move the forming mold to a steam curing room (5) without detaching the drain pipe from the mold of which forming is completed by centrifugal force, in order to cure them with steam at certain temperature and for certain period of time.

At this time, curing at 30-70° C. and for 8-10 hours is recommended as steam curing condition.

Especially, to avoid sudden curing at high temperature, it is recommended that there should not be any change in temperature exceeding 20° C. per hour.

And, if temperature of the curing equipment is below 30° C., there is risk of reducing required strength because curing temperature is insufficient, which delays initial reaction, and if it is above 70° C., there is also risk of defect that curing is not completed deep into cement because hydration reaction occurs intensively on the surface due to sudden abnormal reaction of cement. Therefore, above mentioned scope of temperature should be maintained.

Next, when the steam curing is completed, detach the forming mold.

This invention improves a drain pipe to be manufactured through this process, i.e. by adding functional additives to cement mixture additionally, it prevents crack or drop-out caused by neutralization of drain pipe manufactured by cement, furthermore, long lifespan of a drain pipe can be realized by suppressing occurrence of micro crack.

Such functional additives are composed of PUD (Waterborne Polyurethane Dispersion) 10-15 weight percent, PVA (Polyvinyl Alcohol) fiber 4-8 weight percent in 2-3 mm size, MEHEC (methylethylhydroxyethylcelluloe) 2-4 weight percent, calcium carbonate 4-6 weight percent, degenerated silicate 2-4 weight percent, epoxy-group emulsion 1-2 weight percent, fluorosilicate magnesium 1-2 weight percent, cyclopentasiloxane 1-2 weight percent, triglycerides 6-10 weight percent, glycidyl neodecanoate 2-4 weight- percent, sodium acrylate copolymer 2-4 weight percent and dichlorodimethylsilane 3-6 weight percent, based on cement 100 weight percent.

Here, above mentioned PUD is added to prevent micro crack and strengthen durability and water proofing through realization of higher tensile strength, compared with existing concrete structure, by providing ductility to concrete.

Especially, it is desirable that above mentioned PVA is added as fibers, with both ends torn off like lint, so that it plays a role of anchor like wedge to improve cohesion substantially when mixing concrete. By adding PUD and PVA to the cement mixture realizes long lifespan and prevention of water leakage through suppression of micro crack by increasing tensile strength, abrasion strength and bending strength while adhesive and cohesive strength is strengthened between concrete.

And, above mentioned MEHEC, being cellulose derivatives composed of chain of anhydrous glucose monomer, is added to strengthen maintenance function, activation of surface and chemical resistance.

Also, above mentioned calcium carbonate is added to prevent concrete structure from becoming neutralized by maintaining alkalescence.

Further, above mentioned degenerated silicate is added to improve strength through chemical reaction with calcareous component of concrete, and to allow function of cohesive & adhesive power and stability & dispersibility of inorganic substance while water proof effect is maximized.

Also, above mentioned epoxy-group emulsion is added to improve adhesive power and toughness through strengthening cohesiveness.

And above mentioned fluorosilicate magnesium is added to prevent discoloration of surface.

Also above mentioned cyclopentasiloxane is added to improve fluidity during concrete forming (manufacturing) by increasing lubricity.

Further, above mentioned triglycerides, being coating agent of which main component is ricinoleic acid, is added especially to increase soil resistance and erosion resistance by improving surface smoothness for outer and inner side respectively.

Further, above mentioned glycidyl neodecanoate, being transparent white liquid phase, is added to allow lubricity while transparency is maintained by suppressing color formation.

Also, above mentioned sodium acrylate copolymer is added to induce homogenized mixing of inorganic mixture.

Further, above mentioned dichlorodimethylsilane is added to strengthen water proof property because it helps formation of coating to surface of resin and it shows very strong hydrophobic property since there are two chlorine atoms of which electro negativity is highest next to fluorine (F).

In addition to this, butyl acetate can be added to above cement mixture in 3-6 weight percent based on cement 100 weight percent, to reinforce erosion resistance and crack resistance more for drain pipe manufactured in accordance with this invention.

At this time, above mentioned butyl acetate contributes to suppress erosion while preventing occurrence of crack by accelerating emulsification of emulsion.

Furthermore, above cement mixture can be composed so that durability is maximized through reinforcing cohesiveness by adding polyamine 2-4 weight percent and isopropyl alcohol 2-4 weight percent, based on cement 100 weight percent.

Hereunder, an embodiment is explained.

### Embodiment 1

A sample drain pipe of 10 cm in diameter and 50 cm in length, is made in accordance with manufacturing method as specified above in detail, using the forming mold manufactured per this invention.

At this time, following functional additives are added to the cement mixture, which is composed of PUD 12 weight percent, PVA fiber 5 weight percent in 2 mm size, MEHEC 2 weight percent, calcium carbonate 4 weight percent, degenerated silicate 3 weight percent, epoxy-group emulsion 2 weight percent, fluorosilicate magnesium 1.5 weight percent, cydopentasiloxane 1.5 weight percent, triglycerides 7 weight percent, glycidyl neodecanoate 3 weight percent, sodium acrylate copolymer 3 weight percent and dichlorodimethylsilane 4 weight percent, based on cement 100 weight percent.

### Embodiment 2

Sample is manufactured in same method as Embodiment 1 above, except that butyl acetate 4 weight percent, based on cement 100 weight percent, is added more to cement mixture.

### Embodiment 3

Sample is manufactured in the same method as Embodiment 2 above, except that polyamine 3 weight percent and isopropyl alcohol 2 weight percent, based on cement 100 weight percent, are added more to the cement mixture.

Samples of drain pipe so manufactured in the method explained in above Embodiments 1, 2 and 3, are immersed in water tank of 1 m×2 m×1 m, and samples are left for 2 months as they are, while seawater is injected and circulated by pump.

Also, carbon dioxide is radiated for 10 minutes in every 2 hours for 15 days, to samples of drain pipe of Embodiments 1, 2 and 3 which have been left for 2 months as they are.

Thereafter, it is left in bare ground for 6 months under natural condition and cleaned with seawater, and when it is completely dried by leaving it in laboratory for 3 days, phenolphthalein reagent is sprayed to samples of drain pipe of Embodiments 1, 2 and 3 to check change in color.

Generally, concrete, after curing, maintains alkaline property of pH 12.4˜13, therefore when phenolphthalein reagent is sprayed, it has dark red color. However, when neutralization progresses and pH becomes 8˜8.5, and reagent is sprayed, then it is changed to colorlessness. Therefore, you can easily check whether neutralization progresses or not.

All samples of drain pipe of Embodiments 1, 2 and 3 exposed to severe condition manufactured according to this invention, have shown red color when reagent is applied. Therefore, we can confirm that neutralization has not progressed even under severe condition.

Further, we have checked 5 places of samples with magnifying lens to identify crack, however micro crack was not checked either.

Also, to check erosion resistance, sample was exposed to severe condition for 2 months that seawater was injected and circulated by pump. The result of inspection shows that as for Embodiment 1, one minor defect which looks like micro erosion was detected locally in one place inside throughout whole length, however it was too small to predicate it to be erosion exactly, anyway minute difference in smoothness was confirmed. But erosion was not confirmed at all for Embodiment 2 and 3.

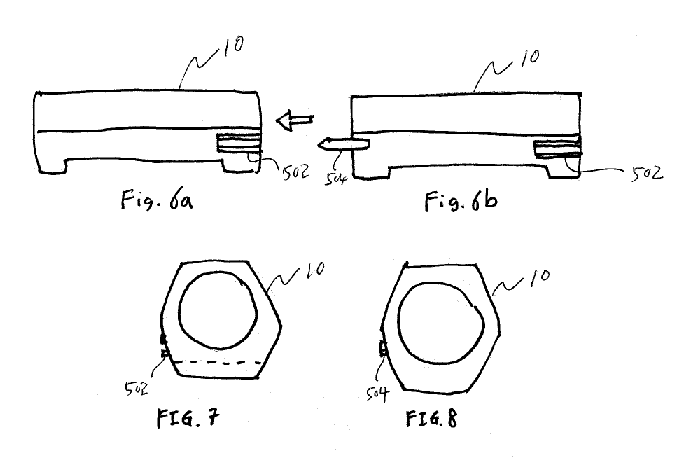

FIGS. 6a, 6b, 7 and 8 show a guide that facilitate aligned assembly of adjacent drain pipes (10). The guide comprises a guide channel (502) provided at one end of the drain pipe (10) and an insert (504) provided at the other side of the drain pipe (10) and is guided into the guide channel (520) when two adjacent drain pipes (10) are assembled. The guide channel (502) and the insert (504) are provided on the inclined surface of the drain pipe (10) so that the guide channel (502) and the insert (504) do not protrude beyond the width the drain pipe (10).

### EXPLANATION OF REFERENCE NUMERAL

| | |
|---|---|
| 10: Drain pipe | 11: Body |
| 12: Waterway | 13: Front supporting block |
| 14: Rear supporting block | 15: Seating groove |
| 16: Member of edge framework | 100: Upper mold |
| 110: Upper body forming space | 120: Seating groove forming block |
| 130: Upper flange unit | 140: Round disk coupling upper |
| | flange unit |
| 200: Bottom mold | 210: Bottom body forming space |

212: Front-supporting block forming space
214: Rear -supporting block forming space
220: Bottom flange unit
230: Round disk coupling bottom flange unit

| | |
|---|---|
| 300: Round disk | 400: Iron core |
| 410: Circular iron core | 420: Connecting iron core |
| 430: Reinforcing iron core | 500: Spacer |
| 502: Guide channel | 504: Insert |

1. A drain pipe, wherein the drain pipe is manufactured from a cement mixture which comprises cement 20-30 weight percent, sand 30-40 weight percent, broken-stone chip 31-45 weight percent in 4-20 mm size, admixture 0.2-0.3 weight percent, and functional additives, wherein the functional additives shall be added and mixed additionally, wherein the functional additives comprise PUD (Waterborne Polyurethane Dispersion) 10-15 weight percent, PVA (Polyvinyl Alcohol) fiber 4-8 weight percent in 2-3 mm size, MEHEC (methylethylhydroxyethylcelluloe) 2-4 weight percent, calcium carbonate 4-6 weight percent, degenerated silicate 2-4 weight percent, epoxy group emulsion 1-2 weight percent, fluorosilicate magnesium 1-2 weight percent, cyclopentasiloxane 1-2 weight percent, triglycerides 6-10 weight percent, glycidyl neodecanoate 2-4 weight percent, sodium acrylate copolymer 2-4 weight percent and dichlorodimethylsilane 3-6 weight percent, and water for remaining portion based on cement 100 weight percent.

2. The drain pipe of claim 1, wherein butyl acetate 3-6 weight percent, based on cement 100 weight percent, is added to the cement mixture.

3. The drain pipe of claim 2, wherein polyamine 2-4 weight percent and isopropyl alcohol 2-4 weight percent, based on cement 100 weight percent, are added to the cement mixture.

4. The drain pipe of claim 3, wherein the drain pipe is manufactured by a method comprising steps of:
a) preparing a forming mold;
b) injecting the cement mixture into the forming mold;
c) spinning the forming mold to form the drain pipe by centrifugal force;
d) moving the drain pipe to a steam curing room without detaching the mold;
e) steam curing the drain pipe for a predetermined period of time at predetermined temperature; and
f) once steam curing is completed, detaching the forming mold to separate the drain pipe.

5. The drain pipe of claim 4, wherein the drain pipe further comprises a guide channel provided at one end of the drain pipe and an insert provided at the other side of the drain pipe, and is guided into the guide channel when, two adjacent drain pipes are assembled, wherein the guide channel and the insert are provided on the inclined surface of the drain pipe so that the guide channel and the insert do not protrude beyond the width the drain pipe.
